(19) United States
(12) Patent Application Publication
(10) Pub. No.: US 2015/0197253 A1
(43) Pub. Date: Jul. 16, 2015

(54) SYSTEM FOR PRESENTING ROAD QUALITY ASSOCIATED WITH OPERATION OF MACHINE

(71) Applicant: Caterpillar Inc., Peoria, IL (US)

(72) Inventor: Yongliang Zhu, Dunlap, IL (US)

(73) Assignee: Caterpillar Inc., Peoria, IL (US)

(21) Appl. No.: 14/151,891

(22) Filed: Jan. 10, 2014

(51) Int. Cl. B60W 40/06; G01P 3/00; G01S 19/00; G01M 17/00

(52) U.S. Cl. CPC B60W 40/06; G01M 17/00; G01P 3/00; G01S 19/00

(57) ABSTRACT

A system is provided for presenting road quality associated with operation of a machine. The system includes a module configured to sense at least one quality parameter associated with a road operated on by the machine. The system further includes a processor communicably coupled to the module. The processor is configured to determine whether the sensed quality parameter exceeds a pre-defined threshold value associated with the quality parameter. The system further includes an indication device communicably coupled to the processor. The indication device is configured to indicate the road quality based on the determination.

### TECHNICAL FIELD

The present disclosure relates to a system for presenting road quality, and more particularly, to a system for presenting road quality associated with operation of a machine.

### BACKGROUND

Ever demanding requirements in the desired quality or finish of work surfaces have driven manufacturers of machines to employ one or more control systems and control an operation of the associated machine. In cases where the machine is a motor grader, a soil compactor, a landfill compactor or similar construction equipment, the control system may be configured to reduce an amount or magnitude of bounce experienced by the machines and avoids scallops or other detrimental effects from occurring on the work surface.

For example, U.S Publication 2013/0292144 (hereinafter referred to as the '144 publication) discloses a system for automated control of a motor grader. The system includes a first sensor to indicate bounce of the motor grader and a speed sensor to indicate the ground speed. A controller determines maximum amplitude of the bounce of the motor grader and controls the ground speed of the motor grader at least in part based upon the maximum amplitude of the bounce.

Although control systems are known to help the machine in maintaining a required degree of finish on a given work site, it may be helpful for an operator of the machine to know of any deviations in the quality or finish at various locations of the work site. The operator may re-work on affected areas of the work site, for example, locations with scallops or other detrimental effects, depending on the deviations in the quality or finish at the affected areas.

### SUMMARY OF THE DISCLOSURE

In one aspect, the present disclosure discloses a system for presenting road quality associated with operation of a machine. The system includes a module configured to sense at least one quality parameter associated with a road operated on by the machine. The system further includes a processor communicably coupled to the module. The processor is configured to determine whether the sensed quality parameter exceeds a pre-defined threshold value associated with the quality parameter. The system further includes an indication device communicably coupled to the processor. The indication device is configured to indicate the road quality based on the determination.

In another aspect, the present disclosure discloses a system for presenting road quality associated with operation of a machine. The system includes a module configured to sense at least one quality parameter associated with a road operated on by the machine. The system further includes a processor communicably coupled to the module. The processor is configured to determine whether the sensed quality parameter exceeds a pre-defined threshold value associated with the quality parameter. The system further includes an indication device communicably coupled to the processor. The indication device is configured to present a map corresponding to a work site in which the machine is present, and indicate road quality of the work site on the map based on the determination.

In another aspect, the present disclosure discloses a method of presenting road quality associated with operation of a machine. The method includes providing a module to sense at least one quality parameter associated with a road operated on by the machine. The method further includes determining, by a processor, whether the sensed quality parameter exceeds a pre-defined threshold value associated with the quality parameter. The method further includes computing a position of the machine relative to the road on which re-work is required. The method further includes indicating, through an indication device, the position of the road, and the road quality associated therewith.

Other features and aspects of this disclosure will be apparent from the following description and the accompanying drawings.

### BRIEF DESCRIPTION OF THE DRAWINGS

FIG. 1 is a schematic and diagrammatic representation of an exemplary worksite;

FIG. 2 is a diagrammatic illustration of an exemplary disclosed machine configured to operate at the worksite of FIG. 1;

FIG. 3 is an exemplary perspective view of a system for presenting road quality associated with operation of the machine, rendered in accordance with an embodiment of the present disclosure;

FIG. 4 is a schematic representation of the system in accordance with various embodiments of the present disclosure; and

FIG. 5 is a method for presenting road quality associated with operation of the machine.

### DETAILED DESCRIPTION

The present disclosure relates to a system for presenting road quality associated with operation of a machine. Wherever possible, the same reference numbers will be used throughout the drawings to refer to the same or the like parts.

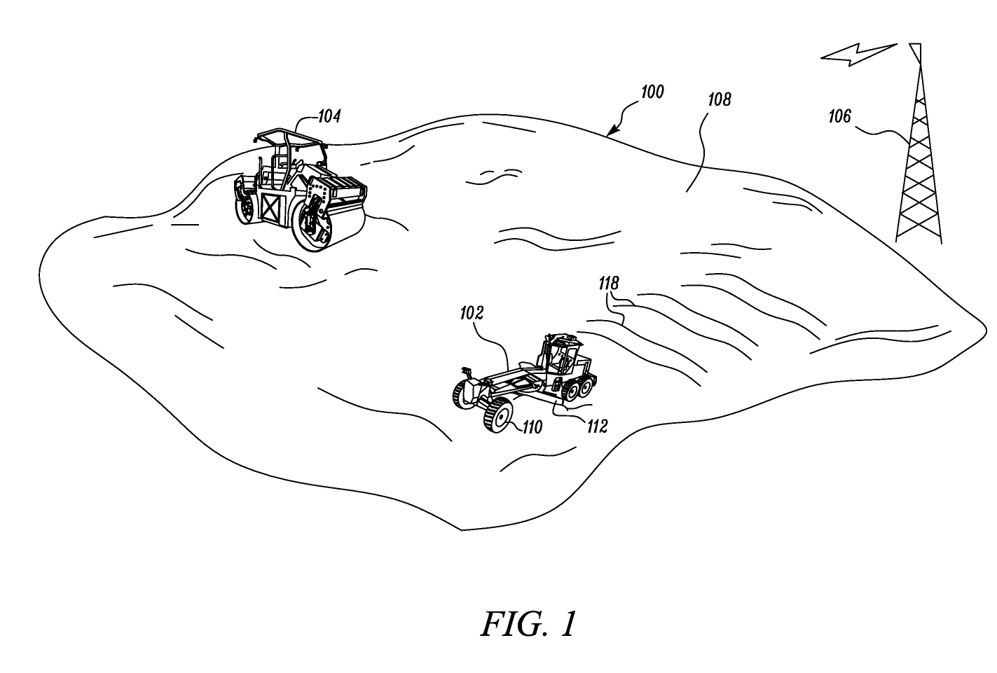

FIG. 1 shows a worksite 100 such as, for example, a soil grading or compacting operation. As part of the soil grading or soil compacting operation, various machines may operate at or between different locations of the worksite 100. These machines may include soil grading machines 102, and soil compacting machines 104. Additionally the machines may include hauling and/or transport machines (not shown), and other types of machines commonly known in the art for performing operations on soil. Each of these machines may be controlled by an operator. However, it is also envisioned to employ autonomous machines in lieu of the operator-controlled machines as will be evident hereinafter. In cases of the machines being autonomous, the machines may be disposed in wireless communication with a central station 106 to remotely transmit and receive operational data and instructions.

A soil grading machine 102 may refer to any machine that is configured to create a flat surface by grading material i.e. soil at the worksite 100 for subsequent operations, for example, for a compacting operation. Examples of soil grading machines 102 may include scrapers, bulldozers, motor graders or other similar machines commonly known in the art to create a flat surface during operation. Multiple soil grading machines 102 may be co-located within a common area of the worksite 100 and may perform similar functions.

A soil compacting machine 104 may refer to any machine that is configured to apply stress on a ground surface 108 of the worksite 100 and cause densification of soil thereon. An operation of the soil compacting machine 104 may immediately follow operation of the soil grading machine 102. Examples of soil compacting machines 104 may include a wheeled or tracked soil compactor, a vibratory soil compactor, a tandem vibratory compactor or any other similar machine. One or more soil compacting machines 104 may co-operate within the worksite 100 to compact soil thereon.

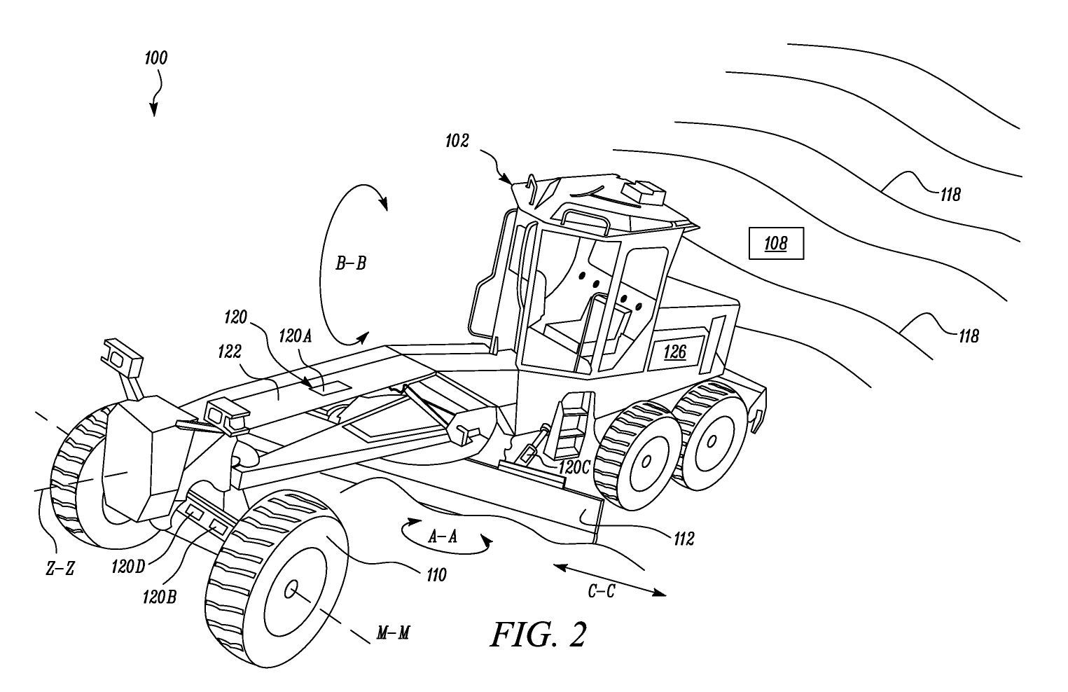

FIG. 2 shows an exemplary machine that is configured to operate at the worksite 100. Although the depicted machine embodies the soil grading machine 102 of FIG. 1, and the present disclosure is explained in conjunction with the soil grading machine 102, it should be noted that systems and methods of the present disclosure may be equally applied to the soil compacting machine 104 or any other similar machine operating at the worksite 100. However, for ease in understanding of the present disclosure, explanation hereinafter will be made with respect to the grading function of the soil grading machine 102 (hereinafter referred to as machine 102).

Referring to FIG. 2, the soil grading machine 102 includes wheels 110 configured to engage with the ground surface 108 and propel the soil grading machine 102 thereon. The wheels 110 disclosed herein are capable of being turned about axis Z-Z to accomplish steering of the soil grading machine 102 on the worksite 100. Further, the wheels 110 are configured to rotate about axis M-M with a ground speed set by an operator via throttle (not shown) or an anti-bounce system 114 as will be explained hereinafter.

Although wheels 110 are shown in the exemplary embodiment of FIG. 2, it is to be noted that a type of ground engaging elements disclosed herein is merely exemplary in nature and hence, non-limiting of this disclosure. Therefore, any type of ground engaging elements may be employed depending upon specific requirements of an application and machine type. For example, endless or continuous tracks may be used in lieu of wheels 110.

The soil grading machine 102 may further include a moldboard 112 configured to operate on the ground surface 108 and perform functions such as, but not limited to, grading soil, digging trenches, producing drainage ditches, or creating cambers. Specifically, the moldboard 112 may be articulated about the pivot planes A-A, and B-B in addition to executing sliding motion in the direction C-C for the purposes of performing the aforesaid functions.

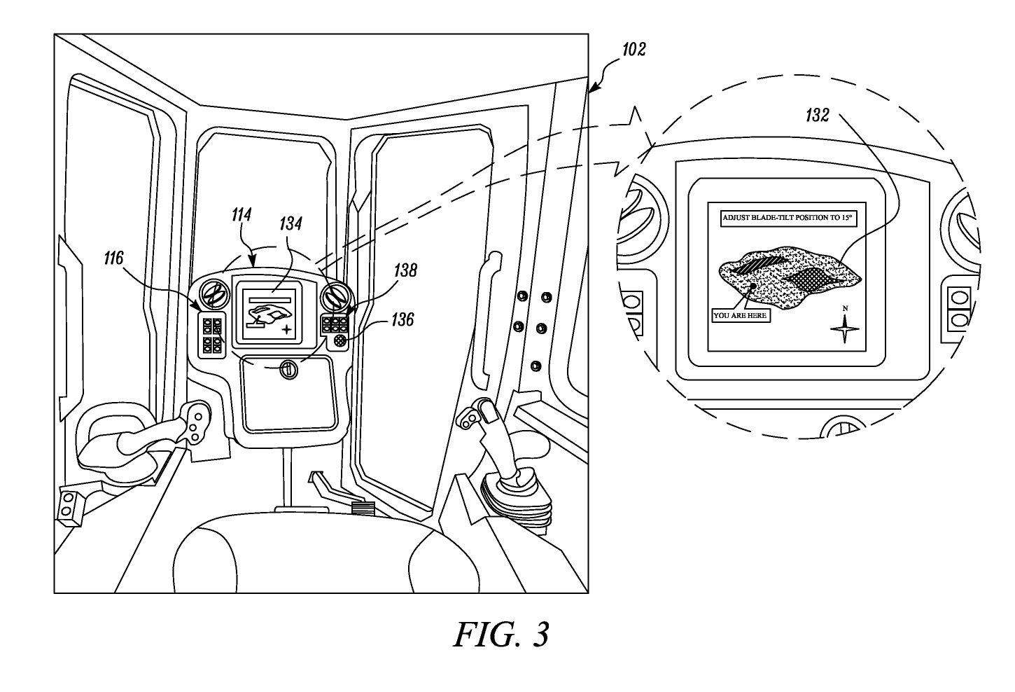

As shown in FIG. 3, the machine 102, disclosed herein, employs a system 114 for presenting road quality associated with operation of the machine 102. The system 114 includes a module 116 configured to sense at least one quality parameter associated with a road previously operated on by the machine 102. The quality parameter, disclosed herein, may include at least one of a frequency of bounce and a severity of bounce in the machine 102 during operation.

A person having ordinary skill in the art will acknowledge that during soil grading operation by the machine 102, the machine 102 may experience bounces due to a variety of reasons. Some reasons for bounces may include, for example, change in engine speed, gear change, articulation of the moldboard 112, non-consistent soil conditions, varying profile or contours of the worksite 100, or objects lying on the ground surface 108 of the worksite 100 that are susceptible of being run over by the moldboard 112. Bounces in the machine 102 may cause the moldboard 112 to form scallops 118 (see FIGS. 1-2) on the ground surface 108 and negatively affect the grading operation performed on the worksite 100 i.e. the quality or finish of the worksite 100 may deteriorate by the formation of scallops 118 thereon. Therefore, the machine 102 may be typically required to re-work the grading operation on the worksite 100 in order to obliterate the scallops 118 and improve the quality or finish of the worksite 100.

With reference to FIGS. 2-4, the module 116 may include at least one of a first sensor 120a, a second sensor 120b, a third sensor 120c, and a fourth sensor 120d. The first, second, third and fourth sensors 120a-d (hereinafter collectively referred to as sensors 120) may be mounted on the machine 102 to measure and detect various aspects of operation of the machine 102. The first sensor 120a may be configured to output geographic co-ordinates associated with the machine 102 and the road on which re-work is required. Accordingly, the first sensor 120a may include, for example, a GPS receiver mounted on a frame 122 of the machine 102.

The second sensor 120b may be configured to measure and output steering angle information pertaining to the machine 102. Accordingly, the second sensor 120b could be, for example, an inclinometer mounted to a steering arrangement (not shown) associated with the wheels 110. The third sensor 120c may be configured to output articulation data associated with an implement of the machine 102 i.e. the moldboard 112. Accordingly, the third sensor 120c could be, for example, an articulation sensor mounted on an actuator arrangement (not shown) associated with the moldboard 112. The fourth sensor 120d may be configured to output wheel speed data of the machine 102. The fourth sensor 120d may include, for example, speed sensors operatively connected to the wheels 110.

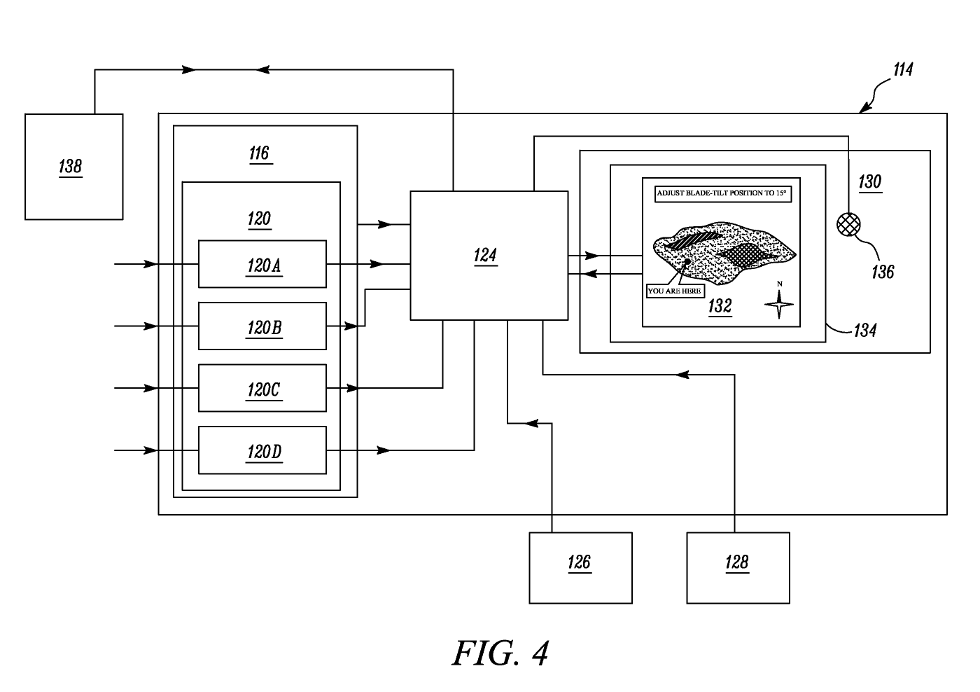

As shown in FIG. 4, the system 114 further includes a processor 124 communicably coupled to the module 116. The processor 124 is configured to determine whether the sensed quality parameter exceeds a pre-defined threshold value associated with the quality parameter. In an embodiment, the processor 124 determines whether a number of bounces as sensed by the module 116 (i.e. number of bounces experienced by the machine 102) exceed a pre-defined number of bounces for a given time of operation or for a pre-defined distance travelled by the machine 102. Although the number of bounces is disclosed herein, it is to be noted that the processor 124 may use the number of bounces during computation to translate and/or determine the frequency of bounces therefrom. Additionally, the processor 124 may determine whether a bounce as sensed by the module 116 is larger in intensity or magnitude with respect to a pre-defined threshold magnitude of bounce set in the module 116.

It is to be noted the processor 124 of the present disclosure is capable of assessing the severity of bounce and the frequency of bounce either individually as disclosed herein, or in combination with each other to estimate a net effect of the bounce on the quality of the worksite 100. Therefore, in some cases, the processor 124 may determine whether the net effect as estimated from the combinatorial assessment exceeds the respective pre-defined threshold values and if so, the processor 124 outputs one or more signals suggestive of re-work on the affected location i.e. location containing scallops 118.

Accordingly, with reference to the present disclosure, it is envisioned that for the purposes of measuring the frequency and severity of bounces, the system 114 may be suitably provided with one or more sensing devices 126 (see FIGS. 2 and 4) and recording devices 128 communicably coupled thereto (see FIG. 4). The sensing devices 126, disclosed herein, may include, for example, accelerometers to measure acceleration forces typically experienced during bounces. The accelerometers may be laser accelerometers, piezoelectric accelerometers, capacitive accelerometers or other types of accelerometers commonly known in the art. Similarly, the recording devices 128 may record a total count or number of instances of the bounce. The recording devices 128, disclosed herein, may include, for example, counters, clocks, shift registers, and other counting systems commonly known to a person ordinarily skilled in the art.

Although certain types of sensing and recording devices 126, 128 have been disclosed herein, it is to be noted that a type of the sensing devices 126 or the recording devices 128 disclosed herein is merely exemplary in nature and non-limiting of this disclosure. Reference to specific types and configurations of sensing or recording devices 126, 128 has been made herein to merely aid the reader's understanding of the present disclosure and hence, should not be taken in the limiting sense. Therefore, a person having ordinary skill in the art will acknowledge that various types of devices and components are readily available and may be suitably employed to perform the functions of sensing and recording the bounces experienced by the machine 102.

Referring to FIG. 4, the system 114 further includes an indication device 130 communicably coupled to the processor 124. The indication device 130 is configured to indicate the road quality based on the determination performed by the processor 124. In an embodiment as shown in FIG. 3, the indication device 130 may be configured to present a map 132 corresponding to the worksite 100 in which the machine 102 is present. Accordingly, the indication device 130 may indicate the road quality of the worksite 100 on the map 132 based on the determination.

Referring to FIGS. 2 and 4, the processor 124 may receive data output from the sensors 120 to compute a position of the machine 102 relative to the road on which re-work is required i.e. the road containing scallops 118 as sensed by the module 116 during a previous operation of the machine 102. The processor 124 may collect information from one or more of the sensors 120 and compute the position of the machine 102 relative to the road on which re-work is required. Thereafter, the processor 124 may initialize the positional data obtained upon computation or directly from the sensors 120 onto the map 132 of the indication device 130, and then display the road quality on the map 132 in conjunction with the positional data.

As shown in FIG. 3, the indication device 130 may include a video interface 134 configured to output navigational data. The video interface 134 may be, for example, a graphical user-interface (GUI) or any other suitable display device configured to provide video functions. Optionally, the video interface 134 may be implemented as a pixelated color display to output various colors therefrom. The pixelated color display may be beneficially used to represent locations with different severities of bounces or locations with different frequencies of bounces on the map 132 with the help of the different colors therein.

For example, if the machine 102 was subjected to or experienced severe bounces at a location on the worksite 100 (i.e. severity of bounce in the machine 102 had exceeded the threshold value preset in the module 116), then that location may be indicated on the map 132 with a first color, for example, red color. Additionally, if the machine 102 was subjected to or experienced frequent bounces at that or another location (i.e. the number of bounces in the machine 102 at that location had exceeded the threshold value for a pre-defined time duration or distance), then that or the other location may accordingly or additionally indicated on the map 132 with the red color.

Alternatively, if the machine 102 experienced less severe bounces at certain locations of the worksite 100 (severity of bounce at the specified certain locations had not exceeded the pre-defined threshold value for severity of bounce) or if a number of bounces at those locations have been recorded as being less than the threshold value for frequency of bounce, such locations may be represented on the map 132 with a second color, for example, yellow color. Further, if the machine 102 did not experience any bounce during operation at certain other locations of the worksite 100, then such locations may be represented on the map 132 in a third color, for example, green color. Use of different colors may distinctly indicate to the operator the locations containing scallops 118 and the locations with acceptable road quality i.e. the locations having little or no scallops 118). Therefore, the video interface 134 together with the map 132 therein may assist the operator in visually identifying the affected areas, i.e. locations containing scallops 118, for performing re-work thereon.

Further, the video interface 134 may be configured to display navigational instructions to the operator with use of navigational assists such as, but not limited to, a compass, an inclinometer or other systems known in the art. Navigational instructions displayed on the video interface 134 may include, for example, “HEAD BACK TO CORRECT GRADING INCONSISTENCY”, “TURN LEFT”, “TURN RIGHT”, “CONTINUE STRAIGHT FOR 500 METERS”, “YOU HAVE REACHED THE AFFECTED LOCATION”, “BLADE-TILT POSITION SHOULD BE HORIZONTAL”, “BLADE-TILT POSITION SHOULD BE 15 DEGREES” etc.

Furthermore, the indication device 130 may additionally include an audio interface 136 configured to output navigational data therefrom. The audio interface 136 may provide navigational data to the operator in audio format. In an embodiment, the audio interface 136 may be configured with interactive voice response (IVR), or other commonly known forms of audio data such as recorded speech and provide navigational instructions at least in part thereof. The processor 124 may thereafter configure the audio interface 136 to audibly direct the operator for moving the machine 102 to the affected road or location on the worksite 100.

In an embodiment, the processor 124 may additionally update the road quality based on re-work performed by the machine 102. Correspondingly, the processor 124 may trigger the video interface 134 of the indication device 130 to display the updated road quality. For instance, if the operator has followed the navigational instructions displayed by the video interface 134 while reaching the affected locations (i.e. locations having scallops 118 of frequency and severity greater than the respective threshold values) and subsequently performed re-work at such locations to improve the grading quality or finish by obliterating the scallops 118, then the processor 124 may receive fresh inputs from the sensing and recording devices 126, 128 and update the road quality based on such re-work. Thereafter, such updated road quality may be displayed on the indication device 130 to let the operator know of the status of the location. For example, a red colored area on the map 132 (indicative of poor grading operation or poor road quality) may be updated with green color to represent that the road quality has now been improved by the re-work performed on the affected location.

Referring to FIGS. 3 and 4, in an embodiment, the machine 102 may employ an anti-bounce control system 138 to selectively reduce a ground speed of the machine 102 depending on the frequency and/or severity of the bounces experienced by the machine 102 during operation on the worksite 100. Further, the system 114 of the present disclosure may be optionally integrated with the anti-bounce control system 138 and may be rendered operational upon actuation of the anti-bounce control system 138 in the machine 102 i.e. the system 114 may be operable when the anti-bounce control system 138 of the machine 102 is in an “ON” state. Since, the anti-bounce control system 138 is typically used during final stages of the grading operation, but not limited thereto, it has been disclosed herein that the present system 114 be operable beneficially in conjunction with anti-bounce control system 138. However, it is to be noted that in alternative embodiments of the present disclosure, the present system 114 may operate independent of the anti-bounce control system 138 i.e. as a stand-alone system in a given machine. Therefore, the use of the present system 114 in conjunction with the anti-bounce control system 138 is to be construed in the illustrative and explanatory sense only and not in any way limiting of this disclosure.

Moreover, in case of a given machine being autonomous, the system 114 may be beneficially provided to the remotely located operator, for example, the system 114 may be provided at the central station 106 from where the operator may remotely control the autonomous machine (See FIG. 1). To facilitate collection, recording, and transmitting of data from the autonomous machine to the remotely located system 114 and vice-versa, the machine 102 may additionally include other components such as, but not limited to, a communication module, an onboard control module, and other modules communicably coupled to the system 114 and suitably configured to execute autonomous operation of the machine. For example, the communication module may be used to send and/or receive information from the system 114 at the central station 106 (i.e. from the remotely located operator) to the autonomous machine 102. The information remotely transmitted to the control module at the autonomous machine may include electronic terrain maps, machine configuration commands, instructions, and/or recommendations. Thereafter, the control module may configure the autonomous machine 102 to execute navigational functions and other operations as required and applicable to the affected locations.

Various modes of operating the system 114, for example, operation of the system 114 in conjunction with the anti-bounce control system 138 and/or independent of the anti-bounce control system 138, and/or for autonomous machines and/or operator controlled machines, etc. are disclosed herein. A person having ordinary skill in the art will appreciate that the foregoing disclosure serves to provide several examples of the system 114 and its manner of operation. However, it is contemplated that other implementations of the disclosure are possible and details of such implementations may differ from those disclosed in the foregoing examples. Therefore, it is to be noted that various additions and/or modifications may be suitably adopted within the system 114 of the present disclosure based on the machine type and/or depending on specific requirements of an application associated thereto without deviating from the scope of the present disclosure.

### INDUSTRIAL APPLICABILITY

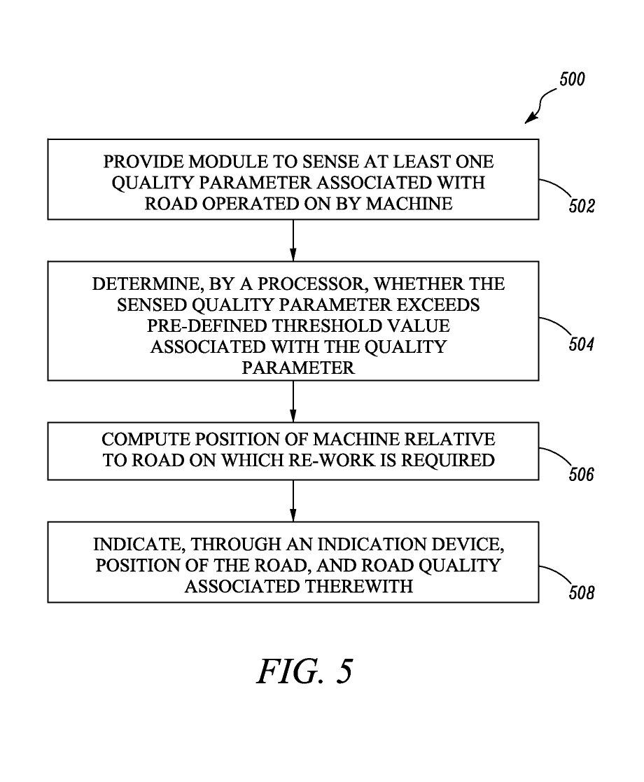

FIG. 5 illustrates a method for presenting road quality associated with operation of the machine 102. At step 502, the method includes providing the module 116 to sense at least one quality parameter associated with the road operated on by the machine 102. The module 116 may be configured to sense quality parameters such as the frequency of bounces, or the severity of the bounces. As disclosed earlier herein, the sensing and recording devices 126, 128 of the module 116 may perform the functions of sensing and recording the frequency of bounces, and the severity of the bounces experienced in the machine 102 during operation.

At step 504, the method further includes determining, by the processor 124, whether the sensed quality parameter exceeds the pre-defined threshold value associated with the quality parameter. For example, the processor 124 may determine whether the frequency and/or severity of bounces exceed the respective pre-defined threshold values preset in the system 114.

At step 506, the method further includes computing the position of the machine 102 relative to the road on which re-work is required. In an embodiment, the method further includes configuring the module 116 to determine geographic co-ordinates associated with the machine 102 and the road on which re-work is required. In another embodiment, the method further includes configuring the module 116 to provide the steering angle information, the wheel speed data, and/or the articulation data (i.e. data pertaining to articulation of the moldboard 112 during operation) to the processor 124. The processor 124 may use some or all of the data provided by the module 116, i.e. from the sensors 120 of the module 116, and determine the aforesaid geographic co-ordinates from such data.

At step 508, the method further includes indicating, through the indication device 130, the position of the road, and the road quality associated therewith. As disclosed earlier herein, the indication device 130 may present the map 132 to indicate the relative positions of the road and the machine 102. Further, the map 132 employs various colors therein to represent various states of road quality corresponding to the worksite 100.

In an embodiment, the method further includes updating the road quality based on re-work performed by the machine 102 and correspondingly displaying the updated road quality at the indication device 130. Therefore, the indication device 130 may present an accurate representation of the road quality in the worksite 100 to the operator and help the operator in taking corrective actions based on the presented road quality.

Implementation of the present system 114 may help operators of construction machines to know the position of the affected locations on the worksite 100. Further, the present system 114 also helps operators to additionally know how much re-work is required on the affected locations depending on the frequency and/or severity of bounces experienced at the affected locations. With use of the system 114 disclosed herein, operators may easily locate areas of concern, i.e. areas of poor grading quality or finish, and take appropriate actions at such areas for improving the road quality of the worksite 100. Consequently, the system 114 may help mitigate time and effort required to perform quality assessment routines after grading of a given worksite since the road quality is readily presented to the operator by the system 114 during operation of the machine 102. Furthermore, the road quality is updated periodically or continually upon execution of any re-work. Therefore, operators of construction machines may find it convenient to maintain a specified road quality or quality of grading operation on the worksite 100 with use of the system 114. Further, construction machines that are contracted to grade a particular worksite may operate more optimally and/or efficiently on the worksite.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

I claim:

1. A system for presenting road quality associated with operation of a machine, the system comprising:
a module configured to sense at least one quality parameter associated with a road operated on by the machine;
a processor communicably coupled to the module, the processor configured to determine whether the sensed quality parameter exceeds a pre-defined threshold value associated with the quality parameter; and
an indication device communicably coupled to the processor, the indication device configured to indicate the road quality based on the determination.

2. The system of claim 1, wherein the quality parameter includes at least one of a frequency of bounce and a severity of bounce in the machine during operation.

3. The system of claim 1, wherein the indication device includes at least one of a video interface and an audio interface configured to output navigational data therein.

4. The system of claim 1, wherein the indication device is configured to present a map corresponding to a work site in which the machine is present, and wherein the indication device indicates road quality of the work site on the map based on the determination.

5. The system of claim 1, wherein the module includes at least one of:
a first sensor configured to output geographic co-ordinates associated with the machine and the road on which re-work is required;
a second sensor configured to provide steering angle information to the processor;
a third sensor configured to provide articulation data associated with an implement of the machine to the processor; and
a fourth sensor configured to provide wheel speed data of the machine to the processor.

6. The system of claim 5, wherein the processor is configured to compute a position of the machine relative to the road on which re-work is required.

7. The system of claim 1, wherein the processor is further configured to update the road quality based on re-work performed by the machine and correspondingly trigger the indication device to display the updated road quality.

8. The system of claim 1, wherein the system is integrated with an anti-bounce control system of the machine, and wherein the system is operable upon actuation of the anti-bounce control system in the machine.

9. The system of claim 8, wherein the anti-bounce control system is configured to selectively reduce a ground speed of the machine depending on at least one of a frequency and severity of bounce in the machine during operation.

10. A system for presenting road quality associated with operation of a machine, the system comprising:
a module configured to sense at least one quality parameter associated with a road operated on by the machine;
a processor communicably coupled to the module, the processor configured to determine whether the sensed quality parameter exceeds a pre-defined threshold value associated with the parameter; and
an indication device communicably coupled to the processor, the indication device configured to present a map corresponding to a work site in which the machine is present, and indicate road quality of the work site on the map based on the determination.

11. The system of claim 10, wherein the quality parameter includes at least one of a frequency of bounce and a severity of bounce in the machine during operation.

12. The system of claim 10, wherein the indication device includes at least one of a video interface and an audio interface configured to output navigational data therein.

13. The system of claim 10, wherein the module includes at least one of:
a first sensor configured to output geographic co-ordinates associated with the machine and the road on which re-work is required;
a second sensor configured to provide steering angle information to the processor;
a third sensor configured to provide articulation data associated with an implement of the machine to the processor; and
a fourth sensor configured to provide wheel speed data of the machine to the processor.

14. The system of claim 13, wherein the processor is configured to compute a position of the machine relative to the road on which re-work is required.

15. The system of claim 10, wherein the processor is further configured to update the road quality based on re-work performed by the machine and correspondingly trigger the indication device to display the updated road quality.

16. The system of claim 10, wherein the system is integrated with an anti-bounce control system of the machine, and wherein the system is operable upon actuation of the anti-bounce control system in the machine.

17. The system of claim 16, wherein the anti-bounce control system is configured to selectively reduce a ground speed of the machine depending on at least one of a frequency and severity of bounce in the machine during operation.

18. A method of presenting road quality associated with operation of a machine, the method comprising:
providing a module to sense at least one quality parameter associated with a road operated on by the machine;
determining, by a processor, whether the sensed quality parameter exceeds a pre-defined threshold value associated with the quality parameter; and
computing a position of the machine relative to the road on which re-work is required;
indicating, through an indication device, the position of the road, and the road quality associated therewith.

19. The method of claim 18, wherein the method further includes updating the road quality based on re-work performed by the machine and correspondingly displaying the updated road quality at the indication device.

20. The method of claim 19, wherein the method further includes configuring the module to perform at least one of:
determining geographic co-ordinates associated with the machine and the road on which re-work is required;
providing steering angle information to the processor;
providing articulation data associated with an implement of the machine to the processor; and
providing wheel speed data of the machine to the processor.
